(19) United States
(12) Patent Application Publication
(10) Pub. No.: US 2006/0294002 A1
(43) Pub. Date: Dec. 28, 2006

(54) Method and apparatus for transacting legal documents

(76) Inventor: Hayton Brett, East Brigton (AU)

Correspondence Address: BROOKS KUSHMAN P.C., 1000 TOWN CENTER, TWENTY-SECOND FLOOR, SOUTHFIELD, MI, 48075, US

(21) Appl. No.: 10/558,544

(22) PCT Filed: May 25, 2004
(86) PCT No.: PCT/AU04/00691

§ 371 Date: Nov. 29, 2005

(30) Foreign Application Priority Data
May 29, 2003 (AU) 2003902645
May 29, 2003 (AU) 2003100400
Apr. 25, 2004 (AU) 20049022165

(51) Int. Cl. G06Q 40/00

(52) U.S. Cl. 705/38

(57) ABSTRACT

The present invention relates to the compiling, transacting and dissemination of legal and associated documents. In one example embodiment, the present invention relates to the handling of documentation associated with Real Estate and Legal industries. In another example embodiment, the present invention relates to conveyancing and the publishing of documentation for viewing by Estate Agents, Lawyers and members of the public such as Prospective buyers. In another embodiment, the present invention relates to on-line publishing of those documents to enable contract preparation. In a still other embodiment, the present invention relates to execution of contracts on-line, and authentication thereof via digital certificates or other suitable secure means.

### FIELD OF INVENTION

The present invention relates to the compiling, transacting and dissemination of legal and associated documents. In one example embodiment, the present invention relates to the handling of documentation associated with Real Estate and Legal industries. In a specific example embodiment, the present invention relates to conveyancing and the publishing on the internet of documentation for viewing by Estate Agents, Lawyers and members of the public such as Prospective buyers. In another embodiment, the present invention relates to on-line publishing of those documents to enable contract preparation. In a still other embodiment, the present invention relates to execution of contracts online, and authentication thereof via digital certificates or other suitable secure means.

### BACKGROUND ART

The production of legal documentation for the sale of property has in general been paper based. This documentation includes the production of a contract and disclosure documentation to comply with the relevant property legislation (“contract documentation”). The contract documentation is generally passed onto an Estate Agent who markets the property by auction or private sale and negotiates the contract of sale between the Vendor and the Prospect. The contract is passed back to the Vendor's Lawyer and sent to the Prospect's Lawyer to complete the conveyancing and transfer of title.

For a Lawyer or conveyancer to produce contract documentation, for example in the State of Victoria. Australia and with a full set of title information and Property Information does require the collection, collation and compilation of up to 30 individual documents and then to photocopy and reproduce the contract documentation up to five times for delivery to the Agent in readiness for an auction or sale by private treaty.

It is considered generally inconvenient that the current system is heavily paper based. All documentation prepared by the Lawyer is collected, photocopied, printed, collated, bound and delivered to the Agent by post, facsimile or courier. This is considered costly and time consuming.

A problem as yet unfulfilled by the prior art is a lack of timeliness in the supply of Property Information and Contrast Documentation to the Agent and Prospective buyer. There are at least four main players in a sale process of a properly. Each player has their own agenda mostly driven by economic factors.

A. The Vendor. The Vendor wants to maximize number of prospects to secure a high sale price and certainty of settlement for the property. The unavailability of Property Information reduces number of serious prospects and this may reflect on the end sale price.

B. The Lawyer: Prepares documentation necessary to effect sale of real estate, and prepares documentation to effect changes of title in real estate and lodges them with the relevant government authorities. Other parties, known as Conveyancers, who are not Lawyers, also prepare documentation to effect changes in title in real estate and lodges them with the relevant government authorities. The term Lawyer is used interchangeably with the term Conveyancer herein. Lawyers are not commission driven, relying upon a flat fee, and thus cost efficiencies, the speed of the transaction, the volume of the transaction, minimizing the cost of transaction and spending as little time and effort as possible in attending to necessities in conducting the conveyance are considered to be a driver of the Lawyer. It has been observed that Lawyers tend to delay delivery of Property Information and contracts to prevent the replication of work due to Agents requiring multiple copies for any transaction.

C. The Agent: The Agent may be a Real Estate Agent or parties who provide property Information on the Internet on behalf of Real Estate Agents, such as:

<www.realestate.com.au>
<www.domain.com.au>
<www.realestateview.com.au>
<www.property.com.au>

It is considered that Agents, being commission driven are generally not motivated to obtain Property Information themselves and consider it a function of the Lawyers and conveyancers. The Agents however desire Property Information as a marketing tool. Hence the Agents require Lawyers to provide them with Property Information and pass on the costs.

The Agent seeks to optimise commission from the sale and volume of the transaction, speed of concluding a transaction and maximising and qualifying the number of prospects. The Agent wants documentation as early as possible in the selling cycle to distribute to Prospective buyers. Typically contract documentation is delivered to the Agent in the week prior to the Auction or in response to an urgent demand or appeal made by the Agent to the Lawyer. Requests for copies of contract documentation are made by Prospective buyers to undertake their due diligence and the Agents have to make additional copies for dissemination to the Prospective buyers of the property. Generally, Lawyers do not deliver contract documentation or part thereof in a timely fashion for a variety of reasons, and this causes the Agents concern as they may be at risk of losing a genuine buyer because of the delays in a Lawyers delivery of contract documentation.

D. Prospective buyers: Prospective buyers tend to want Property Information and Contract Documentation to satisfy their due diligence and to possibly arrange finance in advance. This is not, satisfactorily attended to now.

Often, the Prospective buyer cannot view contract documentation in a timely manner. If they could, it would be considered to greatly assist in completing their due diligence of the property. Prospective buyers are interested in inspection, finance and due diligence in a timely fashion. They generally want to be able to view the contract documentation to determine measurements of the property, covenants & easements, planning, outgoings and any other information that can or may assist in the negotiation of price in their favour. Timely provision of contract documentation can thus assist this process to enable the Prospective buyer to make an offer and if possible seal an agreement to purchase.

E. Financial Institutions: Financial Institutions (FI) provide finance to Prospective buyers. FIs want Property Information and Contract Documentation to prepare mortgage security documentation, undertake valuations of the security properly, to check matters such as planning information, to be sure there are no outstanding levies on the Property and to ensure that the FI's security position is in order. Under the existing paper based system the FI has to obtain such information from the Purchaser or their Conveyancer and undertake their own independent searches.

The timely provision of contract documentation will assist the FI to have the same unfettered access as Prospective buyers. Also giving FIs access to digitally certified and authenticated electronic contract documents will enable them to prepare security documentation, undertake valuations and to check the Property Information for outstanding levies.

In the past, some advances have been made in the ordering and delivery of Property Information from a paper based postal system, to certificates being faxed. Recently Property Information can be now ordered online and delivered by service providers to the Lawyers by email. Nonetheless, the Lawyer still needs to obtain, collate and produce the contract and this is largely paper and labour intensive in nature and thereby considered relatively costly.

One prior art attempt is referred to as “CITEC CONFIRM” which is provided via the State of Queensland, Australia, the details of which are available at the time of wring at:

http://www.confirm.cltec.com.au/index.html

In this model, as exemplified schematically in FIG. 1, the majority of information is government information. In the past, documentation had to be ordered from information providers 100, such as various governing authorities, using paper forms 101, which was time consuming and thus costly. CITEC provided documents in electronic format which resulted in increased speed. But the disadvantage was that documents consisting of multiple pages 102 to 102n were being produced as multiple files. A Lawyer 103 receiving multiple files would still have to prepare the various other forms and documents in a paper based format. The Figure also shows a number of similar Information Providers 100, such as ‘Anstat’ and ‘Legalco’ who provide documents within the State of Victoria, Australia.

Another prior art attempt (not shown) provides the contract information as a single file of about 2 MB In size which meant the time to download such a file via a 56K modem would take a number of minutes. It is considered that this is too time-consuming, especially for people connected to the Internet, and thus the downloading of such big files tends to be done by those who have access to broadband cable technology. However, this is not widely accessible in more remote areas.

Still another prior art attempt is referred to as Electronic Conveyancing Victoria (ECV). FIG. 2 schematically represents this model. In FIG. 2, ECV 200 attends to the whole of the conveyancing process subsequent to the sale of a property, such as between lenders 201, mortgagee 202, and government authorities 203. The ECV model is considered to focus more on the recordal of a sale and related money transactions, rather than the initial sale preparation.

Any discussion of documents, devices, acts or knowledge in this specification is included to explain the context of the invention. It should not be taken as an admission that any of the material forms a part of the prior art base or the common general knowledge in the relevant art in Australia or elsewhere on or before the priority date of the disclosure and claims herein.

### SUMMARY OF INVENTION

The present invention provides, in one aspect, a method of making available information, including documents, relating to the legal and/or real estate industries for viewing and/or printing via the internet, the method including the steps of obtaining information relating to a property in an electronic format, providing the information at a first location, providing a hyperlink for the information between the first location and a second location, wherein the first location is a database or hoist website and the second location is an Agent's website.

Preferably, the present invention brings together disparate information in an electronic format from various sources, inserts it into a database and then automatically publishes them together on a host web page for public inspection. The hyperlink can be provided by various commonly available software packages.

Preferably, the present provides the creation of a database containing Property Information in respect to real estate. The database may be relational or centralised.

Preferably, the Property Information may consist of
a. Property Profile: the property details are disclosed herein and are listed in FIGS. 9A, 9B and 9C.
b. Contract Documentation, such as Property Information, Contract of Sale and Vendor legal Documents. Property Information may include the documents 21 to 39 on FIG. 8. Contract of Sale may include the document 11 to 20 of FIG. 8. Vendor Legal Documents may include the documents 40 to 49 on FIG. 8.

Preferably, the present invention provides for publication of, and access to, Property Information from a webpage by way of hyperlink(s) to a Database or other location where the Property Information resides. The hyperlink may describe the type of Property Information ft provides access to.

Preferably, the Property Information will be published on a web-page (identified with the Lawyer) accessed via the Agents website for 24 hours a day 7 days a week viewing or printing by the Agent, Lawyer, Vendor, Prospective buyer, Purchaser's Lawyer and Financial Institutions.

Preferably, to view the Property Information on the webpage a prospective purchaser as a precondition must sign a Guestbook giving name, email and contact details which can or may be passed back to the Agent.

Preferably, the Property Information can be published in whole or in part with the Lawyer's authorization (or not published for public viewing until the Lawyer is satisfied it is ready to be published).

The present invention provides, in a second aspect, a method of and apparatus for uploading information, including documents, relating to the real estate or legal industries to a database, the method including the step of assigning at least one unique code to each information, where at least one code identifies the property and the type of information.

Preferably, upon uploading of Property information into the Database, unique codes are assigned to each document (codes may be Internet metatags or alpha/numeric codes; code assignment may be automatically generated by computer software or done manually) which identifies the property and the specific type of Property Information.

Preferably, the host of the Lawyers, Website can provide a total print solution for the Contract Documentation to the Lawyer and the Agent. When the Contract Documents are published on the Property Webpage, they may appear in a very specific order, first, the Contract Documents. 11-19, secondly, the Property Information documents 21-39, and thirdly, the Legal Documents 40-49 all identified in FIG. 8. This is the typical order that Property Contracts are collated. In publishing the documents in this order it becomes possible to provide a technical solution to printing the Contract Documentation in this Order by a single command (provided all the requisite documents have been uploaded). This solution may be provided as a bureau service to the Lawyer and the Agent.

Preferably, the present invention (a) gathers all separate and disparate documents into a database, (b) extracts only the relevant documents that are associated with that property, (c) has them sorted into the correct order, (d) merged into a single file, and (e) then printing all by a single command.

Preferably, the Property Information will be displayed In an ordered manner to reflect the same order that a Lawyer would typically create and collate Contract or Auction documentation.

The present invention provides, in a third aspect, a method of editing legal or real estate information, the method including the steps of providing the information as claimed in claim 1 or 2, in a first PDF form, inputting data to a data processing system, and using PDF and FDF technology to import the data into the first PDF form to create a second PDF form.

Preferably, digital verification is provided to the second PDF form. The present invention provides, in a fourth aspect, a webpage and a method of generating a webpage relating to the legal or real estate industries, the webpage including property Information, Agent information, and reference to at least one property document.

Preferably, a checklist is published on the Website to indicate whether an individual Property Information document is supplied, to be supplied, not required, not applicable or on order but not yet available. The Property Database may contain a checklist for all possible Property Information documents that may be associated for any property. The Lawyer, when adding the details of the Vendors may update the checklist. As Property Information documents are uploaded into the Property Database the checklist may be updated either automatically or manually. The checklist status that may be displayed on the Property webpage as viewed by the public and may mirror the checklist on the Property Database.

Preferably, when the Lawyer adds the details of a Vendors Property that includes the Agent's details, the unique hyperlink to the 247 Webage 162 may be automatically generated and then be emailed to the Agent. The Agent may manually insert the hyperlink onto the Agent's Property webpage.

Further aspects of invention relate to online recording of changes of interest in land or real estate, and/or online payment of government levies or taxes.

Throughout the present specification, reference to ‘PDF’ means Adobe Acrobat Portable Document Format or other similar document formatting software tools, and reference to. ‘FDF’ means Adobe Acrobat Form Document Format or other similar document formatting software tools that allows importing data into a PDF-type document.

There are a number of advantages identifiable with the present invention, such as:
1. The bringing together of disparate infiltration in an electronic format from various sources,
2. inserting it into a computer database
3. publishing them together on a host web page
4. accessing of the Property Information from the host webpage via a hyperlink to the database where the Property Information resides
5. checklist published on the web page showing clearly what Property Information documents are supplied, to be supplied or not to be supplied but viewer to make own inquiries
6. with a hyperlink between the Agents web page and the host web page for the Property Information with a compulsory guestbook
7. single repository for all those documents, converted into a common document format base, for example, Adobe Acrobat PDF format, sorted and merged with an ability to enter and merge data into the documents, using, for example, Adobe Acrobat FDF format, and to print such documents
8. cost and time effective over existing methodologies
9. facilitating on-line changes of interests in real estate and/or on-line payment of government levies or taxes

The present invention is considered to provide a meaningful solution for the Lawyer's client who is the Vendor. The Vendor who is selling their property wants to achieve the best price for their property. The Vendor has engaged an estate Agent to market and sell their property for the best possible price. Certain Australian real property legislation requires that the Vendor must provide a disclosure statement and that the contract must be in writing. As described beforehand supply of that information has been only been available in and supplied via a paper based format by the Lawyer for the Vendor who has not delivered the Property Information in a timely fashion. This invention provides for the timely provision of the Property Information in part or in whole.

It is important from the Agents' perspective to have the quickest and best access to the Property Information. This invention can deliver the Property information in a timely fashion which can be viewed by Prospective buyers 24 hours a day, seven days a week by simply following the link from the Agent's webpage to the host webpage for the Property Information.

The Prospective buyers can complete their due diligence on looking at properties they may be interested in buying instantly from anywhere in the world via the Internet Prospective buyers want to be able to inspect the title information, plans, planning information, property outgoings and any other pertinent information on demand instead of pursuing the Agent for such information who is, in turn, pursuing the Lawyer for such Information.

Agents want to know who is interested in buying the property and one of their main tools is when a prospect asks to inspect the Property Information. This invention compels or may compel the Prospective buyer to sign a guestbook in order to gain access to the contract documents on the 247 Website 162 and their details can then be provided to the Agent.

Lawyers understand that a major overhead in the office is the time and cost of collecting, collation and reproducing the Property Information for the Agents. This invention will reduce the Lawyers overheads because of the reduction of reliance of paper and printing as the information is available on the website for Agents to print them themselves.

Agents will have earlier access to Property Information which is what they have always wanted but has never been delivered in a timely fashion. The Agents overheads, too, will be reduced as now they can direct prospects to view the Property Information online instead of the printing and reproduction and physical dissemination of Property Information.

Other aspects and preferred aspects are disclosed in the specification and/or defined in the appended claims, forming a part of the description of the invention.

In essence, the present invention enables the production of a Vendor's Property information without using the photocopier or other paper based forms of media. The problem faced in the past has been the heavy reliance on paper collection collation and reproduction which heavily relied on photocopiers being costly and time consuming. Realising that documentation can be stored on the hard drive of a personal computer or mainframe computer (say in Adobe Acrobat PDF format) led to the idea of integrating those documents into a database that can then be parsed into a webpage viewable online, downloaded and printed at, the location of the person seeking the information.

This realisation, coupled with providing a repository for documentation/information, such as the various property information and documents, as well as property details and Agent details enables the benefits of the present invention to be realised.

A further enhancement is the use of FDF technology in association with documentation related to property transactions. This enables data to be imported into PDF documents, and thus enables PDF documents, and the like, to be integrated with existing office and legal management systems which facilitate the preparation of the various documents necessary to a real estate transaction.

A still further enhancement is the use of digital signatures to enable all parties to execute legal documents and to enable property and/or monetary transfers.

There is also a significant demand for this invention. Prospective buyers are doing more of their research online from their home and office and will enthuse to the possibility of viewing contractual documentation before they make a decision to make an offer to buy.

### DESCRIPTION OF DRAWINGS

Further disclosure, objects, advantages and aspects of the present application, may be better understood by those skilled in the relevant art by reference to the following description of preferred embodiments taken in conjunction with the accompanying drawings, in which:

FIG. 1 illustrates an example of a prior art model for seeking documents,

FIG. 2 illustrates another prior art model referred to as ECV,

FIG. 3 illustrates an overview of an embodiment and a number of inventive aspects disclosed herein,

FIG. 4 illustrates schematically one embodiment of the present invention,

FIG. 5 illustrates schematically an alternative embodiment of the present invention referred to as “the MiniPaK” model,

FIG. 6 illustrates schematically the present invention in more detail particularly the relational database model,

FIG. 7 illustrates schematically a Prospect Flow chart for accessing certificates,

FIG. 8 illustrates schematically an example of Document Codes,

FIGS. 9A, 9B and 9C illustrate schematically an example of a Lawyers' Property Profile Database for use with the present invention, and

FIGS. 10A and 10B illustrate schematically an example of a 247 Website 162 web page in accordance with the present invention.

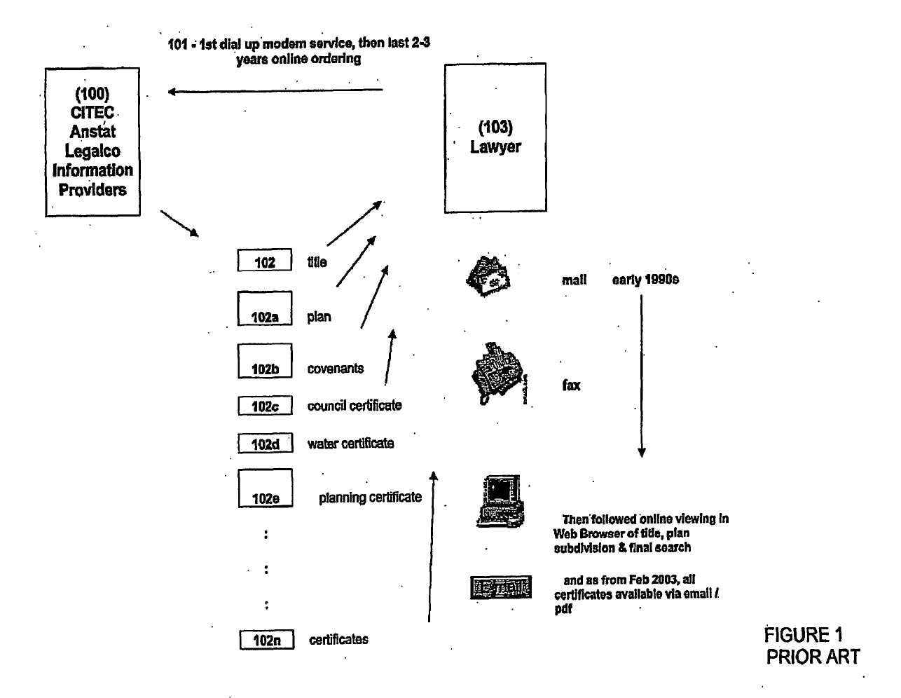

### DETAILED DESCRIPTION

Reference throughout the specification to ‘247’ is a reference to an embodiment of the present invention.

Overview

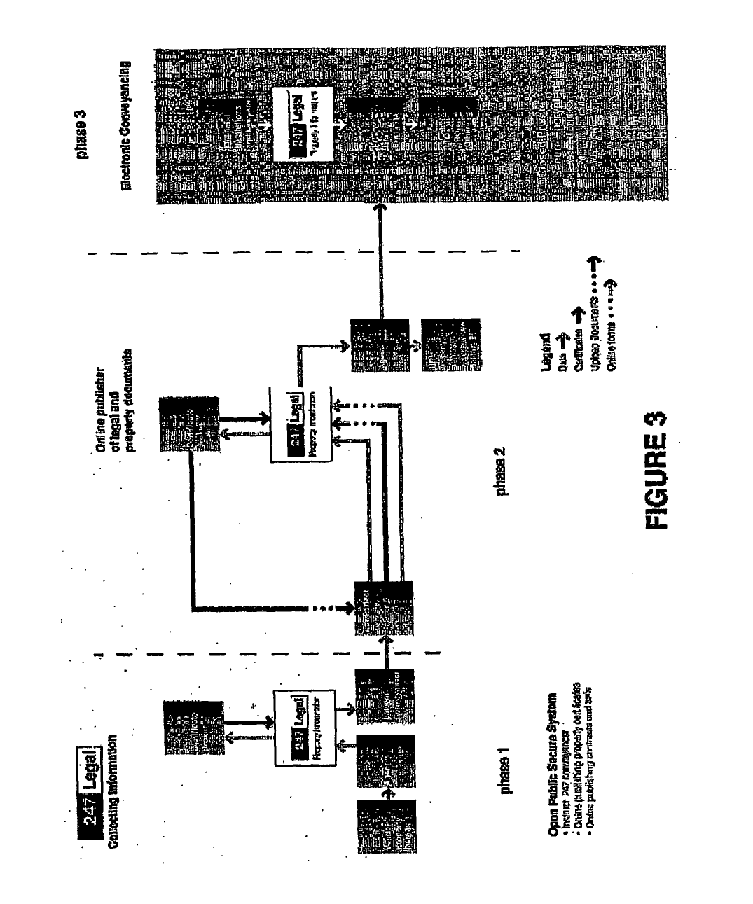

FIG. 3 illustrates an overall view of a number of aspects of invention, and one embodiment of the present invention.

There are 3 phases described. The first phase relates to collecting and sourcing information and making it available in a format suitable for on-line display. The second phase relates to completing and publishing of Property information which are available online. The third phase relates to (on-line) transaction or settlement of property in conclusion of the property transaction. There are a number of aspects with regard to completing of the documents, and verification and authentication related to the embodiment disclosed, which will be explained more fully herein.

In Brief: Phase 1 Realtor

The realtor phase can be made available as a stand alone product for the sale of a suite of Property Information to Agents for online publication on the internet. Prospects will have 24 hours a day 7 days a week access to the certificates via the Agent's website or through the property portals that the Agent uses to market the property on the Internet. The Conveyancer/Lawyer for the Vendor will not have to reorder the certificates, as they will be able to download the certificates (bundled) for free to be incorporated into the Contract documents.

This aspect may have timely delivery of title searches and Property information; published on the internet on or before the Agent has the sale board up on the property; the capturing of Prospect registrations; and web hit statistics and reports fed back to the Agent.

In Brief: Phase 2—Lawyer

The Lawyer phase introduces Conveyancers as well as the online Document Management System (DMS). It is during this phase that all legal documents are published online via DMS. All legal documents may Include the Contract, Disclosure Statement, title and Property information and all other Vendor legal documents, as are required by the Law of the particular jurisdiction where the properly is located. FDF may be used to import, complete and amend information, and amend documents provided in PDF format. Other suitable document technologies/software may be used to iteratively complete and amend documentation.

This phase may interface with existing legal documentation office automation systems, such as that provided by companies like LawPerfect. LawPerfect is one provider of desktop legal software to Lawyers and Conveyancers.

There is considered to be many benefit to Conveyancers and Lawyers in the use of DMS, such as the automation of flexibility of DMS itself, as well as the networking opportunities to generate file referrals from Agents and client referrals to Agents. Some Infrastructure is necessary in terms of database, hardware, hosting and bandwidth. DMS also facilitates the production of contractual documents relating to the sale of real estate, by automatically collating the Contract documentation prior to their printing without the need for the Lawyer to do so, thereby saving time hereinafter referred to as the Print Solution.

Phase 2—Further Enhancement

The Print Solution for Agents and Conveyancers. Once the merged Contract has been prepared and certified by the Lawyer or Conveyancer, the Agent will receive a notification that it is ready for download. When the Agent proceeds to download the merged Contract, a pop up window will give the Agent an option to purchase a hard paper copy of the Contract and Property Information.

The pop up will have, for example:
Size of file
Number of pages
Warning that it is a large file
Notice that a Print Solution is available
Their local Print Franchise can print & deliver X copies in colour or B&W for $Y each
Or even have the Print Solution burnt onto CD's with labels
   In Brief: Phase 3—Electronic Conveyancing (EC)

ECLX is the Victorian state government Instrumentality responsible for introducing a system of effecting of electron online settlements, transfer of title and payments system which it proposes to do by receiving from Vendors and Purchasers electronic ‘data packets’, the information required to effect the recordal of a change of ownership of real property in Victoria. This system is referred to herein as EC.

The present invention can effectively deliver 2 EC compliant Lawyers/Conveyancers to EC. EC needs 2 EC compliant Lawyers/Conveyancers for their system to function. If one Lawyer/Conveyancer is not EC compliant they need to fall back to the paper based system. If the Agent can refer a Prospect to use a Lawyer/Conveyancer who Uses the invention, then the invention can deliver 2 EC compliant Lawyers/Conveyancers.

The data packet required by EC to effect the recording of transfers of title in real estate, electronically, will essentially be complete after the Agent fills in the missing data, i.e. Prospect, price, contract date and settlement date and Prospects Lawyer. The Prospects Lawyer can log onto to 247 and the Lawyers of the Prospect and Vendor complete the property data packet for any missing information, certify the data packet and send it EC for entry into the Register of Titles. The data packet can be re-authenticated in the EC system.

The Invention also effects the generation of electronic PDF contracts through the online DMS. The invention compiles a single PDF file that comprises the Contract, Vendors Statement Title Search, Plan Subdivision, Property information and other documents as required. The compiled PDF Contract can be digitally signed and certified by the Vendor's Lawyer. The Lawyer will be an Adobe digital signature holder. As the Contract is interactive it can be completed online by the Agent and saved. The Contract can be digitally signed and certified by the Agent. The Purchaser's Lawyer, also, can endorse the contract as true and correct As many digital signatures can be added to authenticate the contract.

Financial Institutions (FI) may also want to use the invention. The Purchaser's Lawyer can add the FI as the finance member of the Property Profile.

This will entitle the FI to download the digitally signed and certified contract. The FI will also have access to the individual title and Property Information.

Phase 1—Detail

One example embodiment of the present invention relates to the sale of real estate comprised of securing of government information electronically and information created electronically by the Vendor and the Vendor's Lawyer, legally required to effect the sale, for publication on websites thus enabling public Inspection by prospective purchasers.

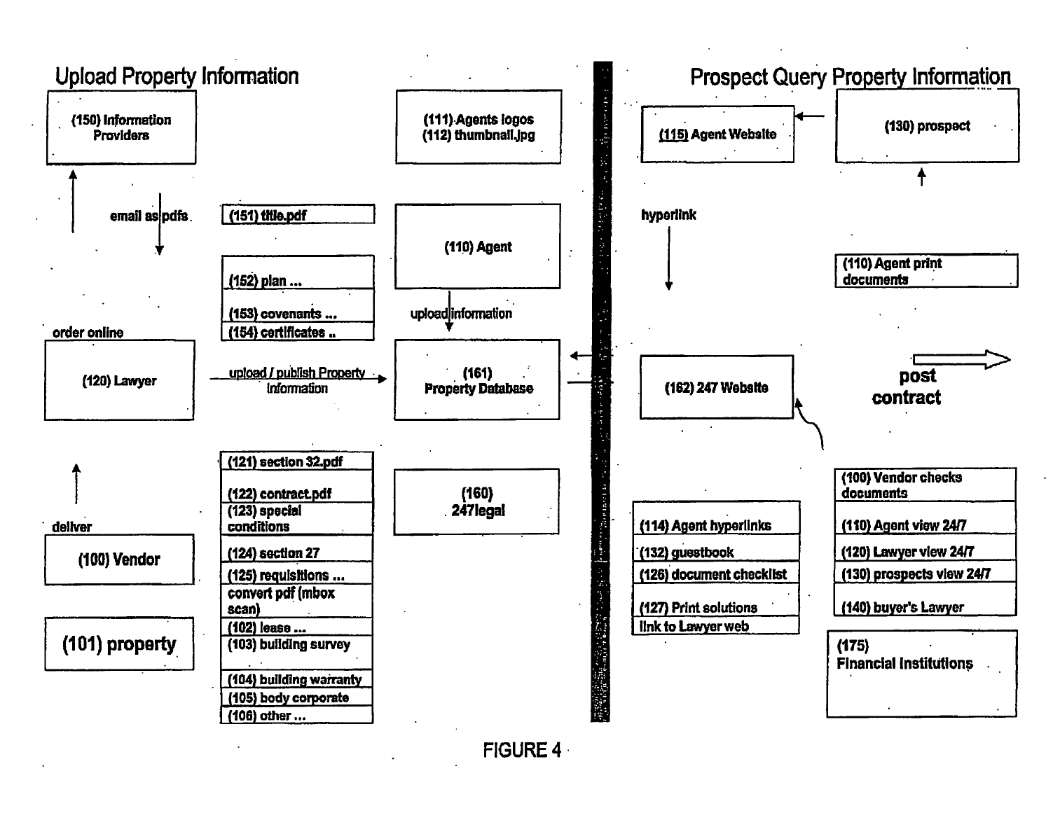

Referring to FIG. 4, there are a number of entities which inter-relate to transact a property sale, namely, the Vendor (100), the Property (101), the Agent (110), the Lawyer (120), the Prospect (130), the Prospects Lawyer (140), the Information Provider (150), 247legal.com.au (160) and Financial Institutions (175) which represents one part of the present invention.

It commences with the Vendor 100 who wants to sell their property 101. The Vendor 100 engages the Agent 110 to sell the property and retains a Lawyer or Conveyancer 120 to act on their behalf. The two main players are the Vendor 100 and the Prospect 130 (who will be the ultimate Buyer). In between are the Agent 110, the Lawyers 120 and the Information Providers 150 Financial Institutions 180 and now 247legal.com.au 160

The Vendor 100

The Vendor having engaged the Agent to sell the Property will retain a Lawyer/Conveyancer to act on their behalf.

The Vendor is the Owner of the Property 101. Their desire is usually to obtain as much money as possible for their property and to secure the settlement. This is achieved by maximizing the number of prospects 130 to acquire the property 101.

The Property 101

The Property may be residential, commercial, industrial, rural, vacant land an apartment or any other type of real estate.

In Victoria, Property under the Sale of Land Act 1962 (Victoria) is defined as follows:

“land” includes land of any tenure, and buildings or parts of buildings (whether the division is horizontal, vertical or made in any other way) and other corporeal hereditaments; and also an undivided share in land and any estate or interest in land.

Property is not a commodity. Property is regulated as to how and what it can be used for and its use is restricted by the local Planning and Zoning regulations. Property is taxed and is affected by council and water levies. It can attract land tax. It might be affected by a body corporate. The Property may be leased. The Buildings on the Property may be classified by the National Trust. The Property may be affected by, a road widening proposal or subject to contamination, or be in a land slip areas subject to, flooding or have had land fill. This list is not exhaustive.

Much of the above can be determined by inspection. Each state in Australia has its own Property legislation and in Victoria for example the Vendor must provide a disclosure statement or Vendor's Statement. The Vendor is obligated to provide certain statutory information regarding the Property before a legally binding contract can be made.

The Agent 110

The Agent (real estate agent) acts for the Vendor for the marketing and negotiation of the sale of the Property. The Agent may also use an Agent to assist in the promotion of the property on the internet via such intermediaries such as www.realestate.com.au or www.property.com.au

The Agent liaises with the Prospects and keeps the Vendor informed as to the extent of interest expressed by Prospects, feedback and to convey any offers.

The Agent and the Vendor set a marketing program and budget which covers classified advertising, brochures, floor plans, display board, magazine and website.

The Agent also uses the Property Information ((151)-(154)) as a marketing tool.

The Property Information are, for example, the title and property information that state Government and Statutory authorities have that affect every Property and contains Important Information such as the certificate of title, the plan of subdivision, any encumbrances such as covenants or easements, planning information, council and water levies, land tax, building and occupancy permits, contamination etc. Property Information are typically obtained from intermediaries described as Information Providers (150) but they can be obtained direct from the Government and Statutory authorities by application and payment of a fee. The Property Information allows the Prospects to do their due diligence on the Property. Title information allows the Prospect to identify the Property, conduct a survey of the measurements and assess the potential for development. The title will also disclose all registered easements, covenants, mortgages and caveats. Planning information discloses the zoning and enabling determination as to whether the current use is legal or what the alternate use the Property can be put to in future. The Prospect wants to know what the current outgoings and levies appertain the Property. Does the Property have a contamination order? What are the body corporate levies or regulations? Are there any outstanding orders or arrears of land tax, council or water rates?

The Agent can use the Property Information 151-154 as a marketing tool as they answer many of the myriad questions prospects have.

For reasons of cost and efficiency the Agent gets the Vendors Lawyer to obtain the Property Information.

The Agent is relatively commission driven. When the Agent sets a marketing budget the obtaining of Property Information is left to the Lawyer and it is seen as a legal function. The standing status quo is the Lawyer applies for the Property Information on the Vendor's behalf and provides the Property Information with the legal and contractual documentation.

The Lawyer 120

The Vendor engages the Lawyer or Conveyancer to act on their behalf and prepare the documentation as required to effect a disposal of the property and to provide legal counsel. Herein Lawyer shall also be interchangeably used with Conveyancer.

There are many steps to take in the sale process. The Lawyer starts by taking detailed instructions from the Vendor regarding the Property and then, for example:
Ascertains the title information such as the Lot/Plan and/or Volume/Folio
Orders the Property Information from a Information Provider (150)
Collects from the Vendor other property information such as any Lease, building information and body corporate information
Prepares the Contract of Sale and Vendors Statement
Collates the Property Information, other Information from the Vendor and the Contract of Sale & Vendors Statement (hereinafter referred to as the Contract Documentation)
Makes multiple copies of the Contract Documentation
Couriers or delivers the Contract Documentation to the Agent.
   The above describes a Pre-Contractual process.

The Agent will often request copies of the Property Information before the Lawyer has completed the Contract Documentation which for the Lawyer means duplication of his job. The Lawyer's problem is that his fee is often fixed and therefore any additional work is not being compensated. Because the Lawyer receives a flat fee for acting for a Vendor they wish to expend as little as time and energy in preparing contracts and obtaining Property Information. Lawyers are also relatively volume driven.

Although it does vary from Country to Country and region to region, in the state of Victoria, Australia, to effect a sale, the Vendor produces a Vendors Statement which discloses certain information on the property, which includes in it the Property Information.

If the Lawyer fails to supply all the Information required to be supplied in the statements or certificates required to be given by this section, the Prospect may rescind any contract for the sale of the land which has been entered into on the basis of that information at any time before title is accepted and therefore becomes entitled to possession or to the receipt of rents and profits, as is defined by the relevant Laws, such as section 32(5) Sale of Land Act (Victoria).

The Prospect 130

For any Property there is only one Buyer but usually more than one Prospect. Prospects are potential buyers. The Prospect may be acting as an Agent for others.

The Prospect searches out properties that they are interested in buying. In being faced with those options they will research the likely valuation for that Property. What are the land measurements or how many square metres is the apartment? The size of the property will be a gauge of the property valuation on a dollar per square metro basis and provides a comparion bench mark with similar properties that have been sold. They will want to know much of the information that is presented within the Property Information such as government charges appertaining to the Property and the planning information. This process is the due diligence that every Prospect should or does conduct. (“due diligence”) The prospect may need to arrange finance and the FI and its valuers will want the information contained in the Property Information.

The Prospect is the party potentially making the greatest commitments both financially and legally. Consequently, the Property information inspection is an integral part of the due diligence by any Prospect.

The Prospect's Lawyer 140

The Prospect can request his Lawyer to view the Property Information and to give advice on any matter or concern the Prospect has before an offer to purchase is made.

The Prospect's Lawyer may actually make Inquiries on behalf of the Prospect. To give counsel to a Prospect before they buy it would be a great advantage to have ready access to the Contract Documents. Viewing the Property Information and to advise on the Title and Planning Information and any other available legal information as well as the Contract requires this information can be provided in a timely fashion which it often is not, frequently not provided until the day before the Auction, is there a better system?

The Information Provider 150

The Information Provider's may be any source, such as for example in the State of Victoria, Australia, commercial organizations such as Legalco, CITEC and Anstat commercially supply the Properly Information in an electronic form to the Lawyer ordering the Property Information via the Internet and the Information Provider delivering the Property Information by email in, for example, Adobe, Acrobat PDF format (151) (152), (153) & (164) in a timely fashion.

The information Provider acts as an Intermediary between the originator of the Property Information (eg Titles Office & local councils) and those who wish to obtain them, acting as a single commercial repository for obtaining Property Information.

The Information Provider does not publish any Property Information on the Internet for public access. Rather, they only supply Property Information directly to those who order and pay for them.

247legal.com.au—Property Database 161

The present invention, referred to as 247 Webserver 162, may be a website where Property Information is published.

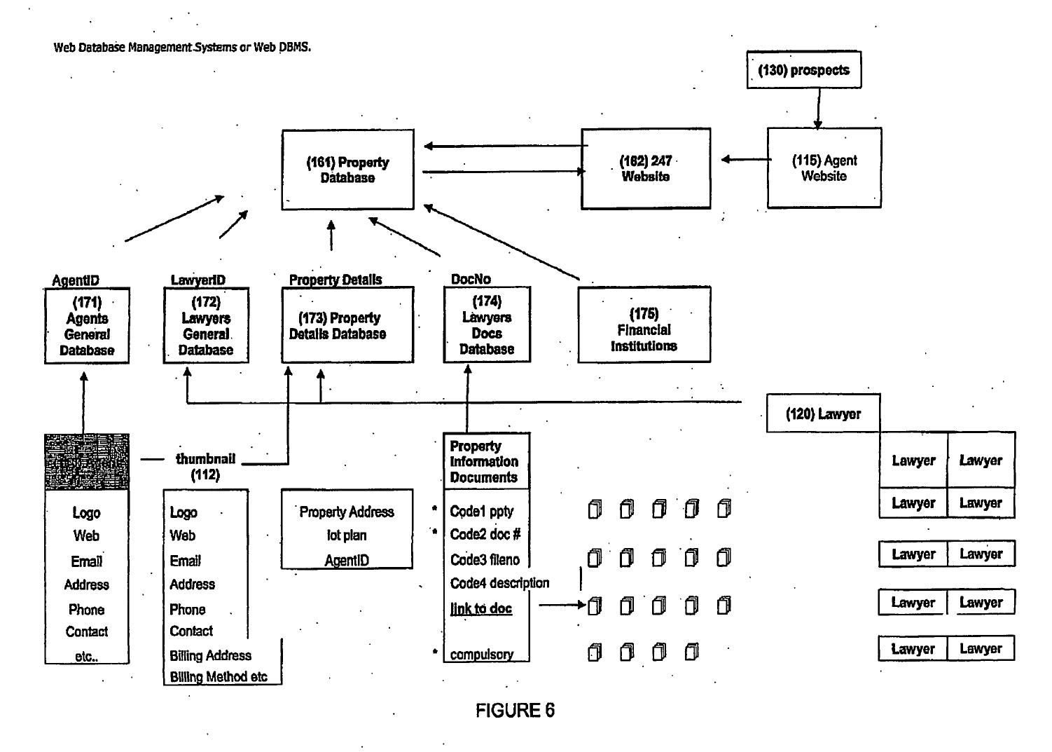

The Property Database 161 resides on the 247 Webserver 162. The Database is made up of, for example, four databases, such as Agent General 171, Lawyer General 172, Property details 173. Lawyers Documents 174, and Financial Institutions 175 as illustrated in FIG. 6.

The information contained in the Property Database 161 is published in a dynamic manner, by way of a webpage on the 247 Webserver 162. The rendering of the webpage to display the Property Information for the Property is dynamic. It is not static. As various components of the Property Information are logged into the Property-Database 161 these are viewable anytime a Prospect requests to view the Property Information for the Property.

Any Lawyer, Agent or Conveyancer can log onto the 247 Webserver 162 via any Internet web browser, to update their details contained in the Property Database 161, such as address, telephone, email, employees, logo etc.

At any time they, the Vendors Lawyer, Agent or Conveyancer may add a Property and its details. The typical details for the Property will be Unit no., Street No.; Street Address; Suburb; Postcode; Municipality; Lot Number; Plan Subdivision; Title details (Victoria its is Volume/Folio or Lot/Plan); as well as the Vendor's details; Vendor's Lawyer's details or the Agent's details, such addresses, telephone and facsimile numbers, email addresses, and company logos.

At the same time a Property and its details is added into the Property Database 161 a unique property code is created (based on the Lot Plan numbers) by the software which also creates the Property webpage which will reside on 247legal.com.au's webserver 162. The unique Property Code is embedded into the Property webpage as its webpage Identifier. The webpage identifier is emailed to the Agent as a hyperlink for inclusion on the Agents website 115. The hyperlink can be created by any known means, Including available software packages. The coding facilitates the creation of the webpage and the cross referencing of the Property Information to the correct Property. The hyperlink also facilitates the referencing of the Vender, Agent and Vendors Lawyer and Property Information and other information.

The Vendor's Lawyer then uploads the Property Information 151-154 via their web browser. The Vendors Lawyer will during the course of the conveyancing process:
Order Property Information 151-154 from the Information Provider 150. The Information Provider will email the Property Information back to the Vendor's Lawyer as PDF files
Collect other Vendor Legal Documents 102-106 from the Vendor or third parties. These documents such as Leases, building warranties, body corporate certificates and building condition survey report. The Vendor's Lawyer then scans and converts the documents into an electronic format, or else faxes them to the Property Database 161 via the 247 Website 162 which has software to convert the documents Into an electronic format. The Vendor's Lawyer can log onto the Property Database and then tag the faxed documents which are now in the correct format for viewing; and
Create the Contract Documents 121-125 typically In Microsoft Word format and then convert to an electronic formatting using appropriate software.

Alternatively, or in combination, the DMS of the present invention may be used. The DMS has considerably refined this process. DMS fixes this part by Word does automatically converted into PDF format.

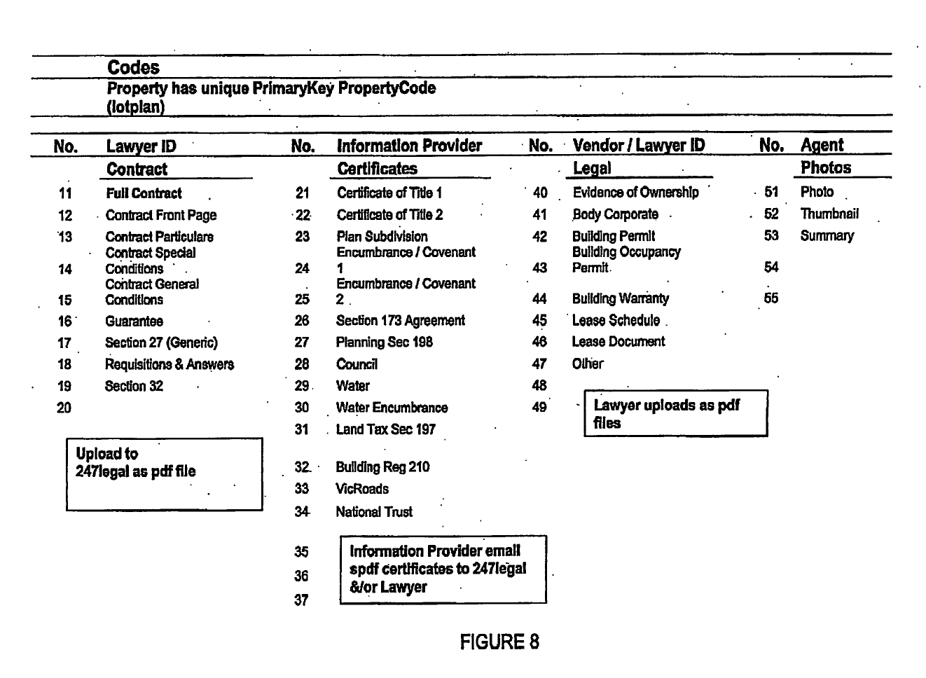

The Property Information 115-154 can be uploaded to the Property Database 161. Each Property Information Document will, be tagged with metadata that will relate that Property Information Document to the Property and describe the type of Property Information Document. FIG. 8 illustrates an example of tagging codes. The numbering of the tags also enables the whole contract and legal documents to be printed sequentially as if it is one document when requested. This enables anyone to obtain a copy of the documents available in an intelligible order. In the tagging process, the Lawyer will select “the Property” and “the Property information type” and to upload select “Insert Document” whereby the Property Information Document will be uploaded onto the Property Database 161.

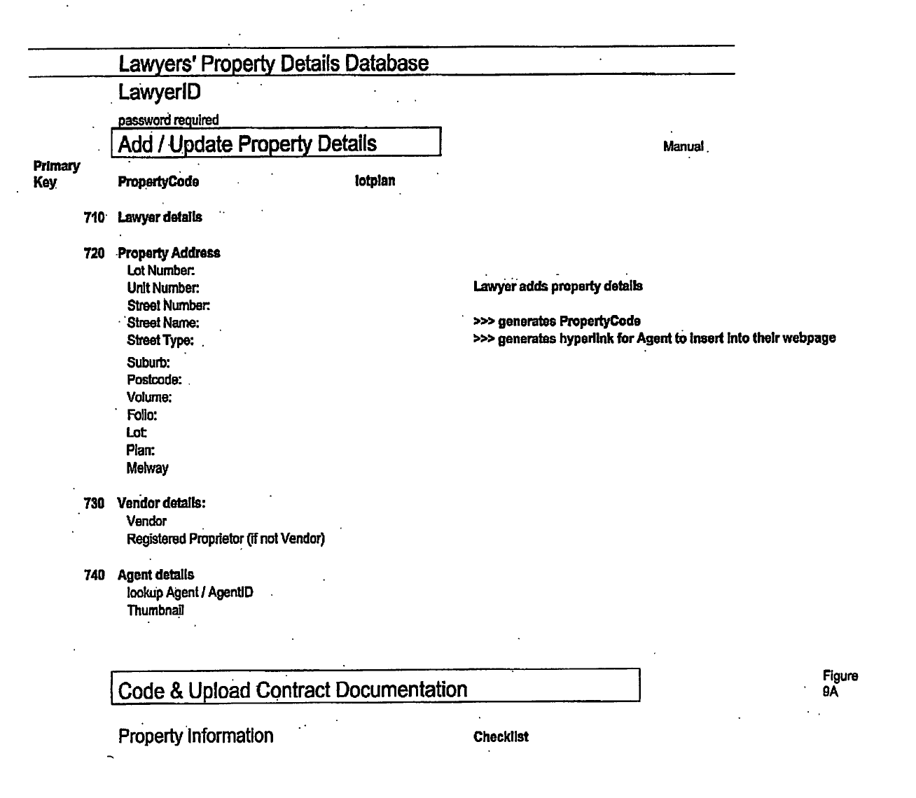

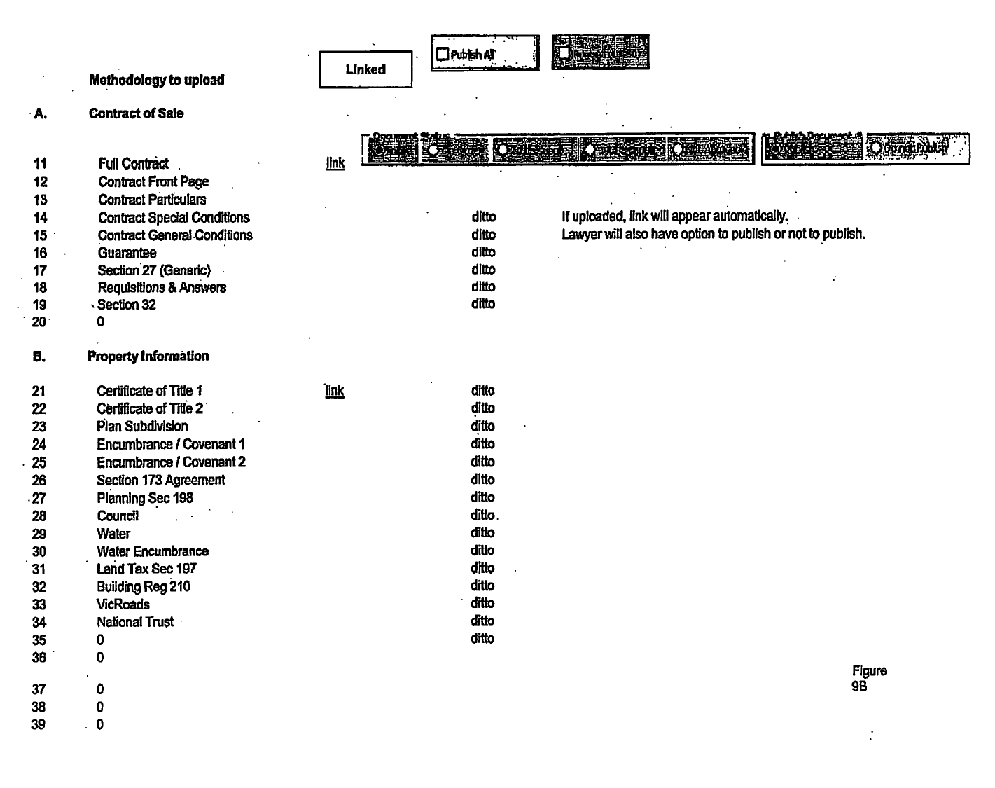

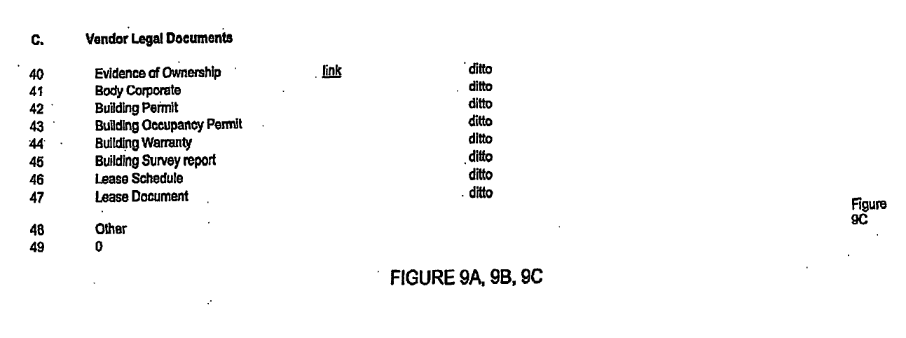

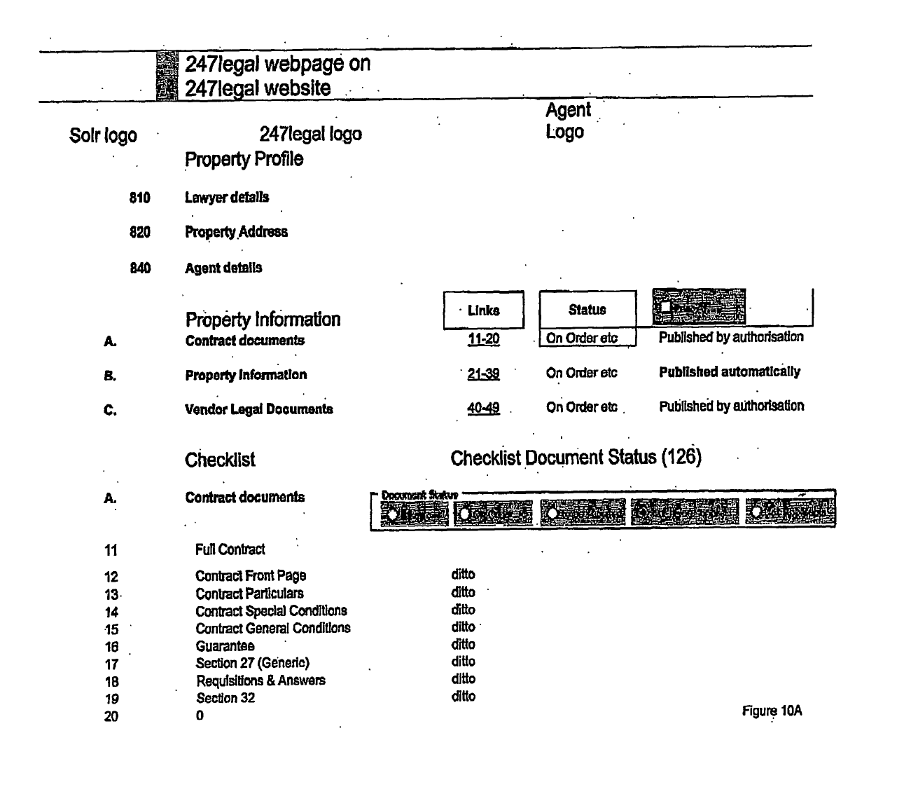

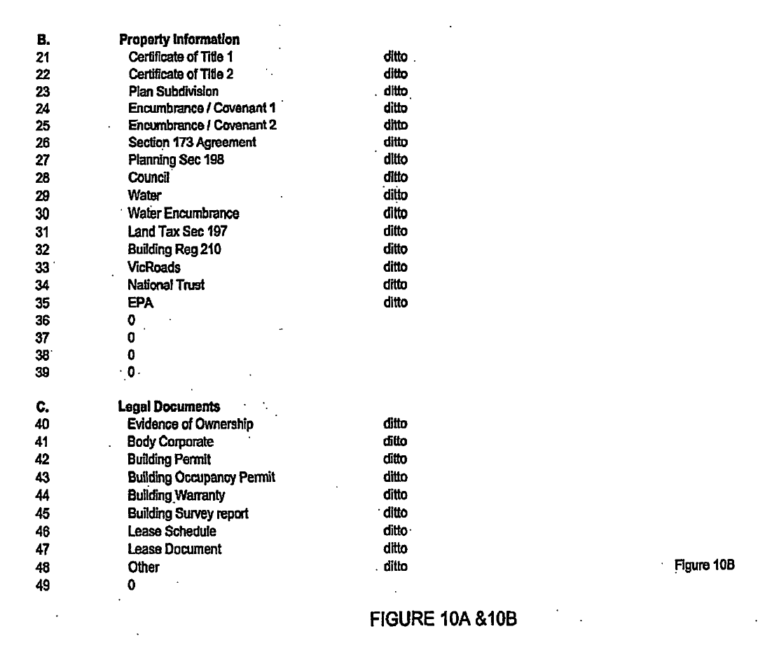

There will also be a Document Checklist 126 on the Property Database so the Lawyer can track which Property Information Documents are “Linked” “On Order”; “Not being supplied”; “Not Applicable”. FIGS. 9A, 9B, 9C, 10A and 10B give more details.

The Checklist is an important tool to the Vendor's Lawyer as well as for all the other parties;

The Vendor's Lawyer can track which documents are and which documents won't form part of the total Property Information. The Vendors Lawyer can then track whether all the documents have been obtained or whether any still remain outstanding. Documents are either: applicable and “On order” or they have been supplied and now “Linked”; or “Not Applicable” or “Not being supplied”. The Vendor's Lawyer has the discretion whether to order or provide a property certificate or not provide it as there is a cost to providing any property certificate. The Vendor's Lawyer may exercise that discretion not to provide a property certificate for monetary reasons or simply considers it does not add any value in providing that particular property certificate. The Vendors Lawyer may elect to publish all or any of the Property Information or not publish at this stage giving the Vendors Lawyer control over what the public and Prospects may view on the 247 Website 162.

The Public can also see the checklist status knowing that if any document that is not published then whether that document will be provided but is simply not yet available.

The Property Information Documents may be tagged “Publish’; or “Do Not Publish” which gives control over what will be published on the 247 Website 162 for the public and Prospects to access. The Vendors Lawyer is responsible to see that the Property Information 151-154 is in order. The first step is to upload the Property Information 151-154 onto the Property Database 161. The Vendor's Lawyer needs to then check that the Contract Documents are in order and is satisfied they are ready to be published for public and Prospects to view. There can be costly ramifications for any documents being inaccurate.

The Prospect viewing the webpage on the 247 Website 162 can view the Property Information Documents that are published and links are provided to view individual Property Information 151-154 documents. They will also be able to view a Checklist of documents that are “On Order” or “Not being supplied” or “Not Applicable”. This gives anyone viewing the webpage on the 247 Website 162 an immediate indication of the type and details of the information available from the 247 Website 162.

As the Vendor's Lawyer receives the Contract Documents these documents can be inserted and uploaded (FIG. 6) into the Property Database 161. The system being dynamic the Prospects and the Agent can view and print the available Property Information 151-154 documents and the status of all Property Information 151-154 documents.

The Property Page when viewed on the webpage on the 247 Website 162 may typically have the following information:
Property description or address
Photograph of the property
Agent logo with link back to Agent's website
Vendor Lawyer's Logo with link back to Vendor Lawyer's website
Summary of Property
Links to individual to Contract Documents viewable in PDF format
Links to individual Property Information each viewable in PDF format
Links to individual Vendor Legal Documents each viewable in PDF format
Checklist of documents not yet supplied but to be supplied or simply Not Applicable
Disclaimer or Warning which typically could read as “Until all certificates are uploaded and the Vendor has signed the Section 32 Statement these documents are for information only. We suggest that you seek independent legal advice before signing a contract of sale.”

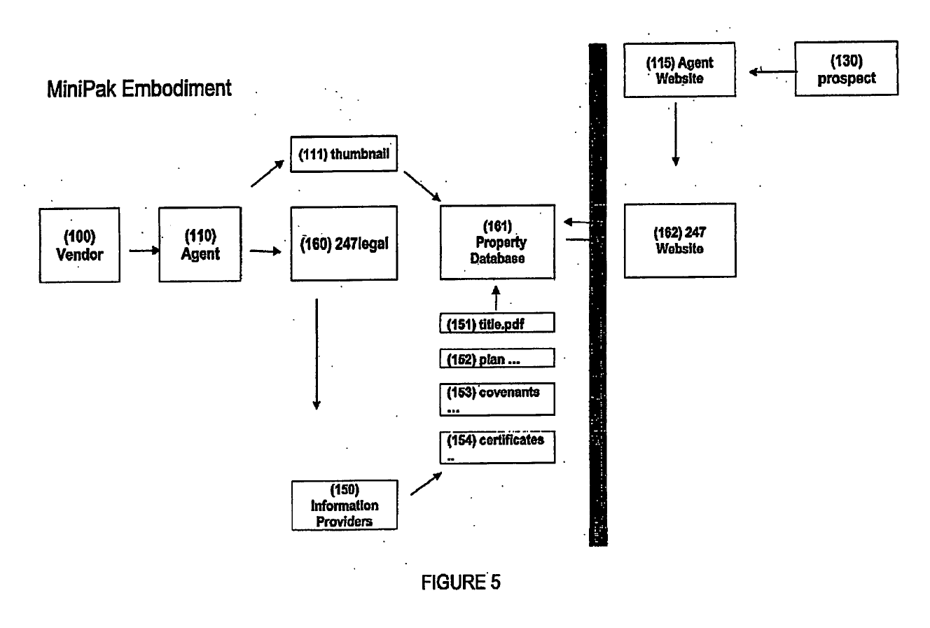

The Agent, also, has the option of ordering a set of Property Information (161)-(154) which 247legal.com.au can provide as a bureau service and these too will be published on the 247 Website 162 (refer FIG. 5) which is the MiniPak embodiment.

Part of the Agent's role as selling Agent for the Vendor is to order photographs of the Property and to create a Property webpage on their own website. The Agent will be able to upload the photographs or Thumbnails (112) of the Property to be inserted and uploaded onto the Property Database 161.

As soon as the Vendor's Lawyer has added a Property and its details into the Property Database 161, the 247 Website 162 will email the Agent with a hyperlink 114 to be inserted Into the Agent's own webpage of the Property linked back to the 247 Website 162 and this will launch/create the correct Property page.

The Agent will have ready access to the Title, the Plan, the Property Information 151-154 and Contract Documents. The Agent can view, download and print all or any of the Property Information 151-154 documents. The Agent can direct Prospects to the Agent's own website and the Prospect follows the hyperlinks to the 247 Website 162 to view the Property Information 151-154 documents. Or the Agent can simply print a copy of the Property Information Property Information 151-154 documents and give them direct to the Prospect.

The Agent no longer has to wait for the Vendor's Lawyer to supply the Property-Information 151-164 documents. As soon as the Vendor's Lawyer has uploaded all or any of the Property Information 151-154 documents they are ready for viewing—24 hours a day, seven days a week.

The Prospect has equal access to the Property Information 151-154 documents as any other party. As soon as the Lawyer has uploaded the Property Information 151-154 documents Into the Property Database 161 any person and that includes the Prospect can view all or any of the Property Information 151-154 documents.

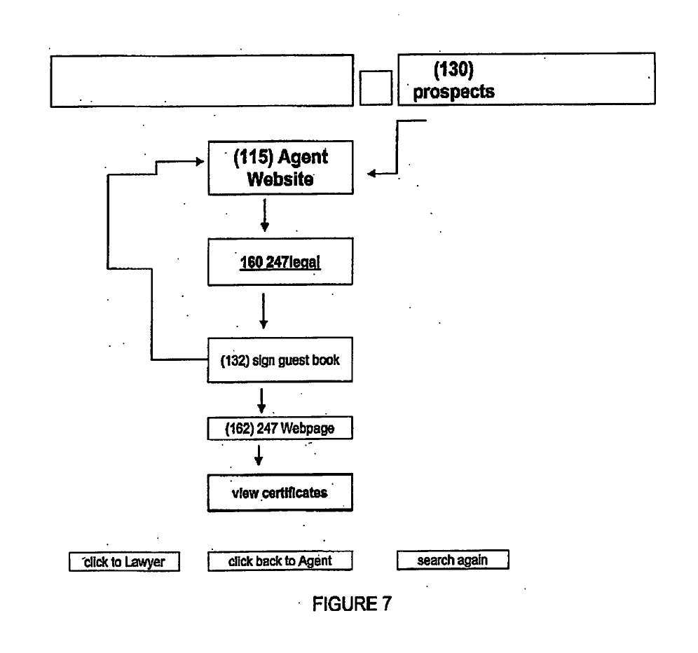

However, In one embodiment, referring to FIG. 7, before the Prospect can view the Property Information 151-154 documents, the Prospect has to complete the Guestbook 132 residing either in the Agent's website or In the 247 Website 162. For the Agent one of the key indicators that a Prospect has more than a passing Interest in a Property is when the Prospect requests to view the Property Information 151-154, if Property Information 151-154 is able to be viewed by the Prospect online, the Prospect need not Interact with the Agent. It is important for the Agent Interact with the Agent to obtain Information from the Prospects, such as personal contact details, opinions on the property and so forth. This can be achieved to an extent by the Prospect completing the Guestbook 132 as a prerequisite to accessing the Property-information 151-154 on the 247 Website 162. When the Prospect views the Property on the Agent's website, they can click on the hyperlink to access the Property Information 151-154, and the Prospect will have to complete the Guestbook as a prerequisite. FIG. 7 illustrates a flow chart which is relatively self explanatory regarding the steps taken for a Prospect to complete the guest book and thereby access the Property Information 151-154.

Typically the Prospect will give their name, email address, contact details, reason for accessing the Property Information 151-154 (simple checkbox—new home, investment, Agent, Lawyer) and comment. This information is given back to the Agent for following up the Prospect. This is important to the Agent because when the Prospect makes a request of an Agent to access Property Information 151-154 documents the Agent knew the Prospect had more than a passing interest in the Property.

The Prospect can complete their due diligence in a timely fashion. The Prospect is in the position then to make a decision to make an offer or to bid at an auction.

There is potentially a lot of upside in the process being conducted in accordance with the present invention. It also reduces the generation of paper copies of Property Information 151-154 which can now simply be viewed online via any personal computer with access to the Internet.

Other embodiments contemplated include:

FIG. 5 illustrates a simplified embodiment of FIG. 3. In this embodiment, 247legal 160 acts as a bureau rather than as the manager of the Property Database 161. The Agent or person requiring access Property Information 151-154 approaches 247legal 160 requesting the Property Information 161-154 documents are obtained on their behalf for publication on a website. 247legal 160 then obtains Property Information 151-154 directly from Information Providers 150, and upon receipt uploads the Property Information 151-154 onto the Property Database 161. The accessing of the Documents is as per FIG. 3.

Decentralized—The Agent or Vendor's Lawyer will obtain, the Property Information 151 from Information Providers 150 and will upload the Property Information 151 onto their own websites for public Inspection alongside general information supplied by the Vendor converted Into an electronic format such as PDF and manually uploaded onto the Agent or Vendor's Lawyer's website as well as contractual information created by the Vendor's Lawyer converted into an electronic format such as PDF and uploaded onto the Agent or Vendor's Lawyer's website.

Centralized—where 247legal 160 that acts on behalf of Agents and Vendor's Lawyers as a bureau, and this is described more fully below.

Phase 2—Detail

FIG. 3 illustrates one embodiment as described above, and FIG. 6 illustrates a further example of this. The present invention will provide and maintain a dynamic web database management system (DBMS), using a database for publication of property and contractual information sourced from: (a) suppliers of government Information, including Information Providers, being Property Information 151-154 (b) Vendors of property or via Agents 110 or Lawyers 120 with those documents converted into electronic format; and (c) Vendor's Lawyers 120 being the contractual documentation converted into electronic format. The Vendor's Lawyer will have access to the Property Database 161 (hosted by 247legal 160 with password protection) with ability to view, add and update the property and contractual documentation with control to publish any or all that information to the Property Database 161 for public viewing via their Internet browser.

The Vendors Lawyer 120 is the “custodian” of the information that is inserted into the databases represented by boxes 172, 173, 174, and 175 (and that information is detailed below the respective boxes 172, 173, 174 and 175). Vendors Lawyer 120 has the ability to add, view, delete or change any of the information contained in the database. Agent 110 has the responsibility to add, view, delete or change the information in the database represented by the information underneath box 171 of FIG. 6. The Public 130 will have access to all property and contractual documentation published on the 247 Website 162 either by link from Agent's website 115 or directly from 247 Website 162.

The present invention is a pre-Contractual tool to assist the Legal and Real Estate industry. All parties may benefit from the Property Information 151-154 and Contract Documents being, published on the Internet so any of the parties can view the documents as they are available. The system encourages the Vendor's Lawyer to have the Property Information 161-154 published at the concurrent time the Agent has the Property published on the Agent's website.

The System may be enhanced to generate paper copies of the Contract of Sale, the Vendors Statement and any other Contractual Documentation. That is, utilize the information loaded into the Property Database 161 to generate such documents. This also extends to the system ordering Property Information 151-154 from the information Providers 150 based on the information loaded onto the Property Database 161.

The present Invention may provide a more efficient way of supplying paper copies of the Contract of Sale, the Vendors Statement and any other Contractual Documentation to the Vendor's Lawyer and Agent. Typically for an auction the Agent requires five copies of the abovementioned documents which forms the Contract Documents. If all the Contract Documents have been published on the Property Database 161, 247legal 160 can provide a bureau print service and deliver bound copies of the abovementioned documents to the Agent and additional copes to the Vendor's Lawyer in preparation for the auction of the Property.

The DMS is considered a sound foundation for pre-contractual disclosure and dissemination of the public Information held by government and statutory authorities relating to any Property in a timely and dynamic manner.

What is referred to as DMS is described as follows:

Online Document Management System (DMS)

Property Contracts are a compilation of legal and Property Information of a disparate rare from a disparate number of sources. One feature is to have a single repository of all those legal documents, converted into a common document formatting base, such as Adobe Acrobat PDF, and then to have them sorted, with the ability to enter and merge data into the documents as required using the function such as that of Adobe Acrobat FDF, to download and to print such documents.

Within the DMS, is the use of software to automatically convert Contract Documents and Property Information 151-154, 121-125 and 102-106 into PDF format when they are uploaded into the DMS if they are already not in PDF format

Such software will be used:
1. if a PDF document is uploaded will check that all security features are disabled (if security features have been enabled an error message will be created).
2. if a Word document (*.doc), or Image file such as jpeg, TIFF or any number of file formats is uploaded, the document or image will be automatically converted into a PDF.
3. If any PDF that is uploaded or converted to PDF format and is larger than, for example, 1 Mb a message will be given warning that this is a large file and will affect download speeds for viewing.
   DMS Elements

There are several elements to the DMS being.
1. Upload data
2. Identifying the documents
3. Identify the source of the documents
4. Collation—Preparing the documents
5. Sort & Merge
6. Publishing and Certification using digital signatures.
7. Print Solutions
8. Use of Libraries and, Templates which are more ostensibly elaborated below
   1-Upload Data

To effect the sale and recording of changes in title to real estate, most Conveyancers or Lawyers use, as a tool, legal software on their personal computer that is a combination of a database with a form merge function, usually but limited to, Microsoft Word, to prepare contractual and other documentation for printing and collating.

The data that is residing within the Lawyer or Conveyancer legal software can be uploaded into the DMS by use of API (Application Programming Interface) software and an Internet connection.

The Vendor's Lawyer or Conveyancer logs onto the DMS, searches for the particular Property Profile of interest and can edit the data by adding, deleting or changing.

2—Identify Documents

The next task is to identify what documents will be included in the final Contract. This can be achieved by either
1. individually selecting the documents from the DMS that will form a part of the final Contract
2. using a template, either determined by the Lawyer or Conveyancer or else pre-determined by the DMS administrator, in the DMS which has the contractual documentation already pre-selected.
3. Use of templates in the DMS will considerably speed up the task of identifying documents. For example, the Lawyer or Conveyancer may have a template called “Industrial”. When they select that template from the list, the required tick boxes are ticked for documents that are required for industrial properties.

Templates can be set up for residential auctions, residential private sates, residential land, residential new houses, residential apartments and flats, residential off the plan apartments, residential house & land. The same applies for commercial, Industrial, rural, project marketing etc

3—Identify the Source of the Documents

The third task is to identify the source of the individual documents on the DMS Property Page. The source of the documents can be one or a combination—
1. upload,
2. DMS library of standard documents,
3. personal library,
4. online ordering of certificates
5. tailored FDF/PDF forms
   4—Collating the Documents

Having Identified the list of documents and their source on the DMS Property Page, the Vendor's Lawyer or Conveyancer is now ready to prepare the documents. The Vendors Lawyer or Conveyancer may use a combination of uploaded documents, library documents, FDF forms and online certificate ordering to complete the task of collation of the documents. As each document task is completed the document may be highlighted by a hyperlink and in that way it is dearly visible to the user that the document has been completed. Property information 151-154 ordered online may give details of when the particular Property Information 151-154 was ordered and date it was delivered.

5—Sort and Merge

The Vendor's Lawyer or Conveyancer needs to set the sort order for the documents in which they will be collated for the final Print version of the Contract.

The full suite of contact documents and certificates may be listed and a print version of the merged Contract may also seen with all the individual contract documents and certificates merged into a single PDF at a given Internet address, for example. The merged document, preferably:
is a compilation of all the individual contract documents and certificates;
that have been sorted into a specific order,
each document has been checked to ensure all security features are disabled;
FDF data forms has had the embedded data stamped into the form;
FDF data forms such as the Particulars of Sale page retains blank fields that need to remain Interactive, such as Purchaser, Price, Deposit Contract Date and Settlement Date.
Front page of the Contract has 3 or more signature fields for Vendor's Lawyer or Conveyancer, Agent and Purchaser's Lawyer Conveyancer to be able to endorse the Contract with their digital signatures;
Merged Into a single PDF document in the specified or default sort order;
The document is annotated with a header or tooter including page numbering, author or other information;
The document is then approved for publication by the party responsible;
   6—Publishing and Digital Signatures

Once approved the Vendors Lawyer or Conveyancer applies their digital signature thereby certifying the Contract as being one that is approved for final execution by the vendor and Prospect. The system will also apply certain security features such as “no changes allowed”. “View only”—“no printing”. The Print Version of the Contract is then available for download by the Agent or the Prospect's Lawyer or Conveyancer.

The print version of the Contract generally will not be available for viewing by the general public. This may be a function that is enabled at the discretion of the Conveyancer or the Agent.

The digital signature is a form of identification of the Lawyer or Conveyancer of either the Prospect or the Vendor in an electronic form which can be created by computer software such as Adobe. Other suitable technologies may be used alternatively or in a complimentary manner. A digital trust service may have a storehouse or repository of digital signatures for use by the Lawyer or Conveyancer of either the Prospect or the Vendor and the Agent. The digital trust service, such as Verisign, will issue, a unique digital signature such parties. The digital signature may be applied using Internet server technology by endorsing the document that resides on the DMS Having a digital trust service, such as Verisign, issue the digital signatures means that any third party, when viewing the digitally certified merged Contract can verify any digital signature is valid by double-clicking the signature field. As long as that party has a live internet connection the signature can be verified by Verisign as a valid or invalid signature.

7—Print Solutions

The merged Contract may be converted to a paper contract or even copied onto a computer storage disc, such as a floppy disk, CD or DVD. In most instances it is the Agent member that will want to download the contract for printing. When the Agent clicks on the merged Contract to download it:
a pop up message will appear
the message will contain information about the document
giving details on the number of pages and the size of the documents
give warning that the document is a large document
give the Agent an option that they can order a paper copy of the contract
if they wish to order paper copies, they will be advised the cost of the Print Service and that the print service will be provided by the nearest Printer in their local area for collection or delivery;
they may simply proceed to download the file for saving to their hard drive and printing using their own resources.
   Templates & Libraries

Use of templates and libraries of precedents will streamline the tasks described above. It is contemplated that the Lawyer or Conveyancer will start using the generic DMS libraries of templates and libraries. These templates can be modified and saved as personal templates. The same may apply to the use of library precedents. Personal libraries may be used by Lawyers or Conveyancers to store their own version of any contractual document for future use and incorporate these into the templates. Lawyers or Conveyancers may upload their own unique documents which will be saved to their library and assign a name to that document. Lawyer or Conveyancer may choose to use their own version of Special Conditions or Guarantees etc.

If the member wants to have a unique version of any FDF form, instructions may be given to the DMS administrator to create or generate that particular form.

Phase 3—Detail

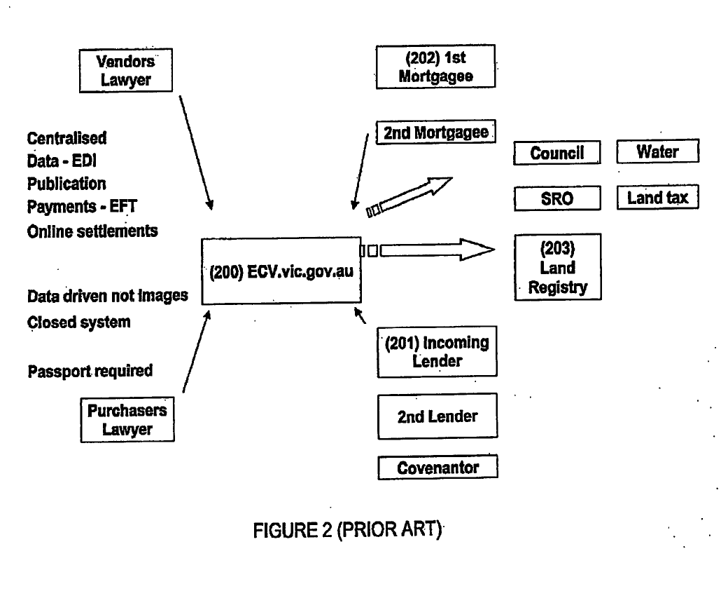

The present invention may be enhanced at later stages to complement a post-contractual recording of changes of interests in real estate on the Register of Titles, by electronic means, such as that proposed by ECV, an example of which is represented schematically in FIG. 2. However, this prior art system is partially, if not primarily, paper based. Thus, there is a need for representatives of all parties to a change of interest in real estate physically meet to effect settlement. This has obvious costs, and timing difficulties.

The Electronic Conveyancing Process—ECLX

There are three components to the electronic conveyancing process (EC)
247legal
Verification
ECLX

247legal is the “front end” for the on-line compilation and publication of legal and property information up to and including the signing of a contract of sale of real estate. An example is disclosed above In Phase 1 and/or Phase 2. ECLX is the proposed Victorian State Government body, responsible for the effecting of a system of electronic online settlement, transfer of the and government tax/levy payments, which it proposes to do by receiving, from Vendors and Purchasers of interests in real estate in Victoria, in electronic “data packets”, the information required to effect the recordal of a change of ownership of real property in Victoria. ECLX is apart of the Victorian titles Office, which maintains a register of ownership and interests in land in Victoria which guarantees indefeasibility of title to those recorded on the register with interests in real estate in Victoria, allowing those who deal with parties recorded on the register in respect of the real estate in question to assume that such recorded interests are indisputable. Consequently, ECLX is most concerned with the accuracy of the “data packets” and their authenticity.

The Verification adds a further layer of authentication of the data packet that is received by ECLX. The Verification also deals with digitally signed PDF contracts.

247Legal—the Front End.

247legal is a commercial Internet-online publisher and compiler of legal and property information acting independent of governmental post-contractual electronic register maintenance systems such as that proposed by ECLX as EC.

As a publisher, 247legal does not provide guarantees for the property details and legal and property information published on its database. Disclaimers are made as to the accuracy of the information published, and that anyone intending to purchase a property must seek their own independent legal advice and due their own due diligence in making enquiries as to real estate up for sale which they are interested in acquiring.

ECLX—the Back End

The Victorian Land Titles Office maintains a register of interests in real in Victoria whose title is determined by state government legislation. Its charter is essentially the Transfer of Land Act 1958, and reference can be made to that document as well as the Transfer of Land (Electronic Transactions) Bill 2004 which is proposed law dealing with the process of effecting transfers of interests in land, and the recording of such changes on the register, by electronic means.

The Register

Presently all transactions with land dealings are paper based, although the Register is now essentially an electronic database of data and Images. Data is mostly composed of the information that is contained on the certificate of title

| | |
|---|---|
| Volume & Folio | Land Titles Office Identifier |
| Land Description | Lot and Plan No. |
| Registered Proprietor | Owner, address, manner of holding |
| Encumbrances, Caveats & Notices | Mortgage |
| | Covenant |
| | Caveats |
| | Statutory Notices |
| | Other Registered Interests |
| Diagram Location | Reference to Imaged Plan |
| Dealings in last 105 days | Unregistered dealings |

The two most common dealings recorded on Register are
1. Sale and Purchase of real estate, Discharge of Mortgage (if Vendor's real estate was subject to one) and recordal of a New Mortgage (if the Purchaser has borrowed from a Financial Institution to acquire the real estate fin the Vendor)
2. Discharge of Mortgage held by a Financial Institution in real estate by the owner of that real estate and the subsequent entering into of a of New Mortgage pursuant to a refinancing arrangement entered Into by the owner of real estate with an alternate Financial Institution.

The first is the normal purchase and sale real estate, and involves not inconsiderable effort to prepare the documentation and effect the transaction by all parties involved, their representatives and the Victorian Titles Office, including an agency agreement between the Vendor and the Agent, preparation of Contract Documentation by the Vendors Lawyer, preparation of loan agreements between the Purchaser and a Financial Institution (if financing from a Financial Institution is required by the Purchaser to acquire the real estate), and finally recording of the change of interests on the register of the Victorian Titles Office.

The second involves two financial institutions (FI) and the real estate owner. Preparation of contractual documentation for the sale of real estate or for the recording of changes in ownership in real estate is not required. The Financial Institution holding the current mortgage provides a discharge of that mortgage and the Financial Institution who the owner of real estate alternately borrows from, registers an Interest In a new mortgage pursuant to that loan arrangement it has entered into with the owner of real estate.

The Victorian Titles Office has not and never been concerned with the financial means by which land is bought and sold, with the exception that the consideration (purchase price) has always been denoted on the Transfer. The Register is only concerned with the legal ownership of real estate, and the recording of such interests on the register, including the recording of security interests such as mortgages and caveats as evidence of a charge.

ECLX has been mandated by the Victorian Titles Office to incorporate into its responsibilities the online effecting of settlements in transfers of interests in real estate along with effecting electronic transfer of the funds used to buy and sell real estate and to effect the entry. Into the register by electronic means changes in ownership of real estate and changes of security interests.

Property Data Packets

In one aspect of the invention, a “data packet” is created, in electronic coded form, the Vendor's information, the Purchasers Information and the Vendor's mortgagee and the Purchaser's mortgagee's information (if such mortgagees exist). The data packet needs to be certified as true and correct by the Vendor, Purchaser and respective mortgages (if applicable) and must be authenticated as true and correct by ECLX via confirmation by the aforesaid parties before the data packet is processed to update the register.

The data packet needs to be secure, and authentication of the data packet by ECLX pursuant to confirmation by the parties to the change of interests in real estate, as absolutely accurate and unquestionable recording of changes of interests in real estate is the highest priority of the Victorian Titles Office, and consequently, protection of the register from fraud and error. Land User Identification cards may be used to effect this purpose As published by ECLX on 8 Jul. 2003: “All parties will be required to enter into an agreement with the Land Exchange (LX—program enabling key land transactions to be completed via the Internet) In order to use the system. Parties using the system must act in an agency role on behalf of their clients and must comply with the LX Public Key Infrastructure security arrangements.

The electronic lodgement file (ELF), together with the security infrastructure, creates the original instruments as required by Land Registry. When provided to the Registrar on electronic lodgement, the information becomes the searchable and auditable item in case of dispute. A non-repudiable digital signature is used to provide this Instrument. There are no paper instruments to be lodged with Land Registry.

ECLX has inbuilt methodologies of identification to confirm and authenticate data contained in the data packet that will be processed to update the register and to reduce errors and the incidence of fraud, as will be disclosed in the following text.

The Double Blind—the Verification

The invention can complement the EC system proposed to be introduced by ECLX, by the creation of a “double blind”. The invention as disclosed herein can create a Property data packet that has been certified as true and correct by the Lawyers or Conveyancers who use the invention. This property data packet can be passed onto ECLX and can be authenticated using the current identification controls that have been set up by ECLX.

Thus the “double blind”. The property data packet has been “verified” twice, reducing the incidence of fraud and error. If desired by ECLX, use of the invention to effect the “double blind” may be a condition by which Lawyers and Conveyancers may use the ECLX as prescribed by the Registrar.

Some of the key provisions of concern to ECLX is:
conditions of access to ECLX (this could be through a front end system such as 247legal)
the Conveyancer is an eligible person (ie a Lawyer or conveyancer with insurance) if they use the invention they could be periodically cross matched to the database of the government instrumentality or private body charged with verifying the Conveyancer's eligibility to use the ECLX system.
the Vendor and Purchaser has authorised their respective Agents by instrument in writing signed by the Vendor or Purchaser to execute the electronic instrument (a copy of the appointment letter can be scanned and uploaded to the DMS and the Victorian Titles Office could have access to inspect such instruments).
refuse to register the Instrument if, in the opinion of the Registrar, the electronic instrument is incomplete or contains errors (the double blind reduces the incident of error and fraud).
   Digitally Signed and Certified PDF Contracts

A second advantage of the invention herein described is the generation of electronic PDF contracts through an online document management system, previously referred to as the DMS.

The invention compiles a single PDF file that comprises the Contract and other Documents required to effect the recording of a change in interest in land.

The compiled PDF Contract can be digitally signed and certified by the Vendor's Lawyer. The Lawyer may be an Adobe digital signature holder. As the Contract is interactive, it may be completed online by the Agent and saved. The Contract may be digitally signed and certified by the Agent. The Purchaser's Lawyer, also may endorse the contract as true and correct. As many digital signatures may be added to authenticate the contract as is required. The contract, and its various iterative versions may be made available at an Internet site, and thus may be available for viewing, completion, amendment, and/or authentication by any party.

The paper contract signed by the parties may be held on a file(s). The present invention lends itself to be relied upon by any third party whether that be a financial institution or the State Revenue Office, Victorian Titles Office, or the Courts, when ascertaining the veracity and authentication of the digitally signed and certified contracts and its contents.

While this invention has been described in connection with specific embodiments thereof, it will be understood that it is capable of further modification(s). This application is intended to cover any variations uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the appended claims. Various modifications and equivalent arrangements are intended to be included within the spirit and scope of the invention and appended claims. Therefore, the specific embodiments are to be understood to be illustrative of the many ways in which the principles of the present invention may be practiced. In the following claims, means-plus-function clauses are intended to cover structures as performing the defined function and not only structural equivalents, but also equivalent structures. For example, although a nail and a screw may not be structural equivalents in that a nail employs a cylindrical surface to secure wooden parts together, whereas a screw employs a helical surface to secure wooden parts together, in the environment of fastening wooden parts, a nail and a screw are equivalent structures.

1. A method of making available information, including documents, relating to the legal and/or real estate industries for viewing and/or printing via the Internet, the method including the steps of:
obtaining information relating to a property in an electronic format,
providing the information at a first location,
providing a hyperlink for the information between the first location and a second location,
wherein the first location is a database or host website and the second location is an Agent's website.

2. A method as claimed in claim 1, further including the step of providing a hyperlink to property information, such as a thumbnail or property photograph.

3. A method as claimed in claim 1, further including the step of providing a hyperlink between property information, such as a thumbnail or property photograph, and associated information.

4. A method of uploading information, including documents, relating to the real estate or legal industries to a database, the method including the step of:
assigning at least one unique code to each information, where the at least one code identifies any one or a combination of the property, the Agent the type of property information.

5. A method as claimed in claim 4, wherein the code is an Internet meta-tag or meta data.

6. A method as claimed in claim 4, wherein the tag enables the information to be displayed in a predetermined order.

7. A method of generating a webpage relating to the legal or real estate industries, the method including the steps of:
providing property information,
providing Agent information, and
providing a reference to at least one property document.

8. A method of generating a webpage as claimed in claim 7, further including the step of, when a property profile including Agent details is added, generating a unique hyperlink to the Agent's website.

9. A method as claimed in claim 8, further including the step of generating an email to the Agent notifying the Agent of the hyperlink generated.

10. A method of editing legal or real estate information, the method including the steps of:
providing the information as claimed in claim 1, in a first PDF form,
inputting data to a data processing system, and using FDF technology to import the data into the first PDF form to create a second PDF form.

11. A method as claimed in claim 10, further including the step of:
providing digital verification to the second PDF form.

12. A method as claimed in claim 1 further including the step of publishing the information with authorisation.

13. Apparatus adapted to make available and/or upload information, including documents, relating to the legal and/or real estate industries for viewing, printing and/or editing via the Internet, said apparatus including:
processor means adapted to operate in accordance with a predetermined instruction set,
said apparatus, in conjunction with said instruction set, being adapted to perform the method as claimed in claim 1.

14. A computer program product including:
a computer usable medium having computer readable program code and computer readable system code embodied on said medium for making available and/or upload information relating to the legal and/or real estate industries within a data processing system, said computer program product including:
computer readable code within said computer usable medium for performing the method as claimed in claim 1.

15. A webpage relating to the legal or real estate industries, the webpage including:
property information,
Agent information, and
reference to at least one property document.

16. A webpage as claimed in claim 15, wherein the reference to at least one document is a hyperlink.

17. A webpage as claimed in claim 15 wherein the Property Information include contract documents, Property Information and/or legal documents.

18. A webpage as claimed in claim 15, further including a checklist as to the availability of at least one property document.

19. A webpage as claimed in claim 15, wherein a status indicator is provided that includes information such as whether the document is linked, on order, to be supplied, not being supplied or not applicable.

20. Apparatus adapted to host a webpage as claimed in claim 15.

21. (canceled)

22. A method of online recording of changes of interest in land or real estate, including a method as claimed in claim 1.

23. A method of online payment of government imposed levies or taxes, in combination with a method as claimed in claim 1.

24. (canceled)

25. (canceled)

26. (canceled)

27. (canceled)
